(19) United States
(12) Patent Application Publication
(10) Pub. No.: US 2007/0076519 A1
(43) Pub. Date: Apr. 5, 2007

(54) Mixing container stabilizing platform

(76) Inventor: David L. Kesling, LaPorte, IN (US)

Correspondence Address: BAKER & DANIELS LLP, 300 NORTH MERIDIAN STREET, SUITE 2700, INDIANAPOLIS, IN, 46204, US

(21) Appl. No.: 11/243,404

(22) Filed: Oct. 4, 2005

(51) Int. Cl. B01F 15/00

(52) U.S. Cl. 366/129

(57) ABSTRACT

An apparatus for stabilizing a container during mixing includes a base platform, an engagement arm and a brace member. The engagement arm is pivotally attached to the base platform via a hinge. Additionally, the engagement arm includes two components hingably affixed together. The brace member is located opposite the engagement arm and includes a receiving portion directed toward the engagement arm for receiving the container to be stabilized. During mixing, an operator applies a force downward on the engagement arm, generally with a foot, thereby retaining the container between the engagement arm and the brace member. The contents of the container may then be stirred without the operator having to straddle the container.

### FIELD OF THE INVENTION

This invention relates generally to a portable device that provides a means for stabilizing and retaining a container while mixing the contents of the container.

### DESCRIPTION OF THE RELATED ART

Modern construction materials used for various construction trades, such as tiling, concrete, drywall, ceilings, paint, driveway sealing, resins, and floor levelers, are typically prepared at the site of the job. Often these types of jobs require the mixing or re-mixing of premixed materials that may have separated while in shipping or storage. Unfortunately, a problem is often encountered while mixing materials, especially when mixing a thick slurry of materials, in which the material adheres to the inner surface of the container. The contact between the material and the container during mixing may cause the container to spin with the material, thereby reducing the effectiveness of the mixing procedure and creating a potential for injury. This problem is further exaggerated when an operator attempts to mix the contents of the container by himself, wherein the operator must support the mixing tool while also preventing the container from rotating.

Traditionally, an operator attempting to mix the contents of a container endeavors to retain the container in a set position by squeezing the container between his lower legs. This method of retention creates the potential for injury to the operator in a number of ways. For example, if the operator were to loosen his grip on the container during mixing, the container may begin to spin and could potentially injure the legs of the operator. Further, if the operator completely loses hold of the container, the rotating container could possibly injure the feet of the operator, which are located in close proximity to the container. Additionally, this method of retaining the container requires the operator to straddle the container in a manner that places undue stress on the back of the operator.

Numerous devices have been developed in the prior art to overcome some of the problems above. For example, U.S. Pat. No. 5,232,188 discloses a mixing pail jig for supporting a pail during mixing operations. The jig includes a support ring that may be distorted into an elliptical condition during mixing. The jig also includes foot pads provided at right angles to the support ring and extending downward therefrom. When mixing the contents of a container located within the support ring, the operator straddles the container and stands on the foot pads thereby distorting the support ring. As the support ring bows, the ring contacts the bucket and consequently, retains the bucket in a set position during the mixing operation.

U.S. Pat. No. 6,361,001 discloses a device similar to the above-discussed jig entitled a container holder. The container holder is used when mixing slurry material in either a 2.5- or 5-gallon bucket. The container holder includes a one-piece raised top portion having a centrally disposed aperture. Two legs extend downward from the top portion and continue the length of the bucket. Each leg includes a foot pad. During the mixing procedure, the operator places the container holder over a container and stands on the foot pedals, thereby causing the top portion of the holder to engage the container. The engagement between the container and the holder is intended to retain the container in a set position during mixing.

Another device for retaining a container during mixing is described in U.S. Pat. No. 6,464,184 and is entitled apparatus for retaining a canister. The described apparatus includes an adjustable base and preferably two swing members attached to the base opposite each other via a hinge, such that the swing members pivot with respect to the base. Each swing member also includes a semicircular recess located opposite the hinge. The apparatus also includes a spring member for retaining the swing member in an open position. Additionally, the base of the apparatus is adjustable to provide an adjustable range of motion in the swing member. During a mixing operation, the operator straddles the canister and stands on the swing members, thereby overcoming the spring force and retaining the canister between the swing members.

### SUMMARY OF THE INVENTION

The present invention relates to an apparatus for securing a container during mixing including a base, an arm attached to the base, and a brace member. In an embodiment of the invention, the brace member is rigidly secured to the base, while the arm is secured to the base via a hinge. The arm and the brace member cooperatively engage the container in order to prevent the container from rotating.

In one embodiment of the invention, the arm includes first and second members pivotally connected together. The second member engages the container when retaining the container in the apparatus. In addition, the first member is pivotally connected to the base of the apparatus thereby allowing the entire arm to pivot with respect to the base.

In an embodiment of the invention, the brace member includes at least one arcuate portion for receiving a container. Each arcuate portion is configured to receive containers of a specific diameter. Additionally, the arcuate portions are directed toward the engagement arm, thereby allowing the container to be forced against an arcuate portion of the brace member in order to prevent the container from rotating during mixing. In one embodiment of the invention, the operator, while mixing the contents of the container, may prevent the container from rotating with only one foot and may allow the operator to prevent the rotation of the container without having to straddle the container.

### BRIEF DESCRIPTION OF THE DRAWINGS

These and other features of the invention will become more apparent and the present invention will be better understood upon consideration of the following description and the accompanying drawings wherein:

The accompanying drawings illustrate the present invention. In such drawings, FIG. 1 depicts a perspective view of a first embodiment of the present invention;

FIG. 2 depicts a perspective view of a second embodiment to the present invention;

FIG. 3 depicts a side view of the first embodiment illustrating the loading of the invention;

FIG. 4 depicts a perspective view of the first embodiment of the invention retaining a container;

FIG. 5 depicts a perspective view of the first embodiment of the invention retaining a container of a different diameter; and

FIG. 6 depicts an operator performing a mixing operation involving the present invention.

### DETAILED DESCRIPTION OF AN EMBODIMENT OF THE INVENTION

The embodiment of the invention described herein is not intended to be exhaustive, nor to limit the invention to the precise forms disclosed. Rather, the embodiment selected for description has been chosen to enable one skilled in the art to practice the invention.

With reference first to FIG. 1, numeral 10 generally indicates a mixing container stabilizing platform. Stabilizing platform 10 comprises base 12, engagement arm 14 and brace assembly 16. As depicted, base 12 has a substantially planar form with a rectangular shape. Generally, base 12 may be manufactured from any type of material capable of supporting large weights or forces, such as wood, heavy duty plastic or metal. As illustrated, base 12 includes a substantially smooth upper surface 13 and a lower surface located opposite thereof (not shown).

Referring still to FIG. 1, engagement arm 14 is attached to upper surface 13 and includes first portion 18, second portion 20, first hinge 22 and second hinge 24. First portion 18 and second portion 20 have substantially planar shapes and may be manufactured from materials generally capable of resisting loads with little or no deflection. For example, in one embodiment each of first portion 18 and second portion 20 may be manufactured from wood. In alternative embodiments, however, first portion 18 and second portion 20 may be manufactured from plastic, steel or any other similar material.

First hinge 22 connects first portion 18 to second portion 20 in a manner allowing pivotal movement between the two portions 18 and 20. Hinge 22 may be of any type capable of providing the requisite movement, and further, may be affixed to the first portion 18 and second portion 20 by way of any means, such as by way of fasteners (not shown) or an alternative method. As depicted, first hinge 22 generally joins one of the ends of first portion 18 to second portion 20, however, first hinge 22 may be attached to second portion 20 at an alternative position if desired. Second portion 20 includes an engagement surface 26 that is substantially planar on located opposite hinge 22.

A second hinge 24 is attached to first portion 18 on the end opposite that joined to first hinge 22. Second hinge 24 connects first portion 18 to upper surface 13 of base 12 in a conventional manner. This type of connection allows first portion 18 to pivot with respect to upper surface 13.

Referring still to FIG. 1, brace assembly 16 can be manufactured from any suitable material such as plastic or wood and is affixed to upper surface 13 facing engagement arm 14 with a receiving portion directed toward engagement arm 14. Brace assembly 16 is secured to base 12 in a conventional fashion. For example, fasteners (not shown) or adhesives can be employed to secure the brace member 16 to base 12.

Receiving portion 27 comprises an open area within brace assembly 16. In the embodiment depicted, receiving portion 27 includes arcuate portions 28 and arcuate portion 30. As can be seen in FIG. 1, arcuate portions 28 each have the same radius of curvature and are positioned to receive a cylindrical object of a first diameter. Arcuate portion 30 is positioned intermediate portions 28 and has a radius of curvature sized to receive a cylindrical object with a second diameter smaller than the first. Each arcuate portion 28, 30 includes front face 32, which in alternative embodiments, may include rubber or similar material (not shown) attached thereto, in order to increase the coefficient of friction of the front face. It should be noted that in alternative embodiments, arcuate portions 28 and arcuate portion 30 may be replaced with a single arcuate portion, or further, may include additionally arcuate portions as desired.

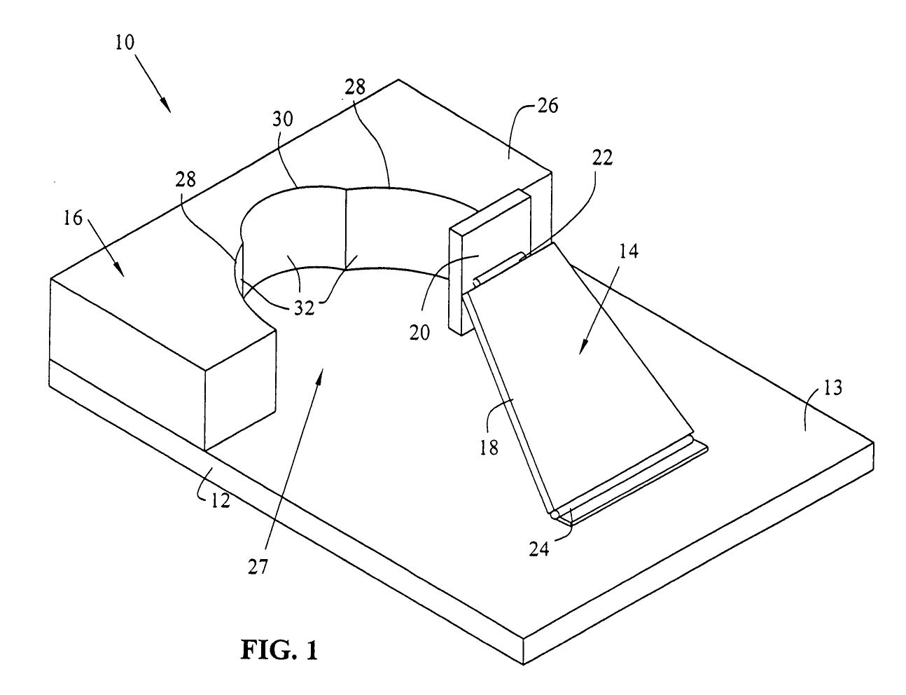

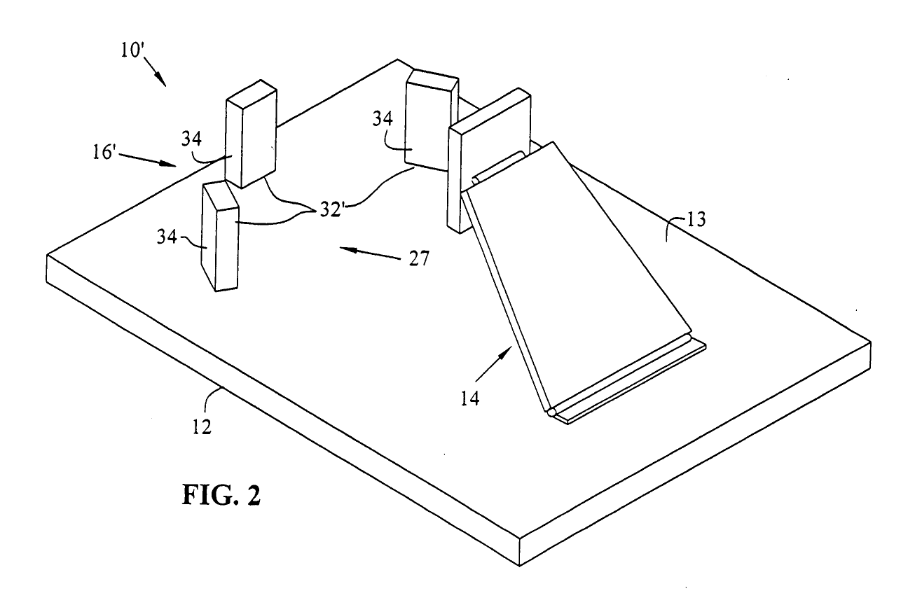

FIG. 2 depicts an alternative embodiment of apparatus 10′. The depicted apparatus 10′ includes base 12 and engagement arm 14, each identical to that previously described with reference to the first embodiment of the invention. Apparatus 10′, however, includes an alternative brace assembly 16′ comprising a plurality of stoppers 34. Stoppers 34 are secured to upper surface 13 of base 12 by any conventional mechanism. For example, stoppers 34 may be fastened to upper surface 13 by a plurality of fasteners (not shown), or in alternative embodiments, stoppers 34 may be secured to upper surface 13 by an adhesive. As depicted in FIG. 2, stoppers are arranged to create a receiving portion 27′ similar to that described with respect to the previous embodiment of the apparatus 10. Similarly, each of the stoppers 34 includes a modified front face 32′ similar to the front face 32 (FIG. 1) of arcuate portion 30 (FIG. 1). Similar to that described previously, the modified front face 32′ may include a known means of increasing the coefficient of friction of stoppers 34, such as rubber.

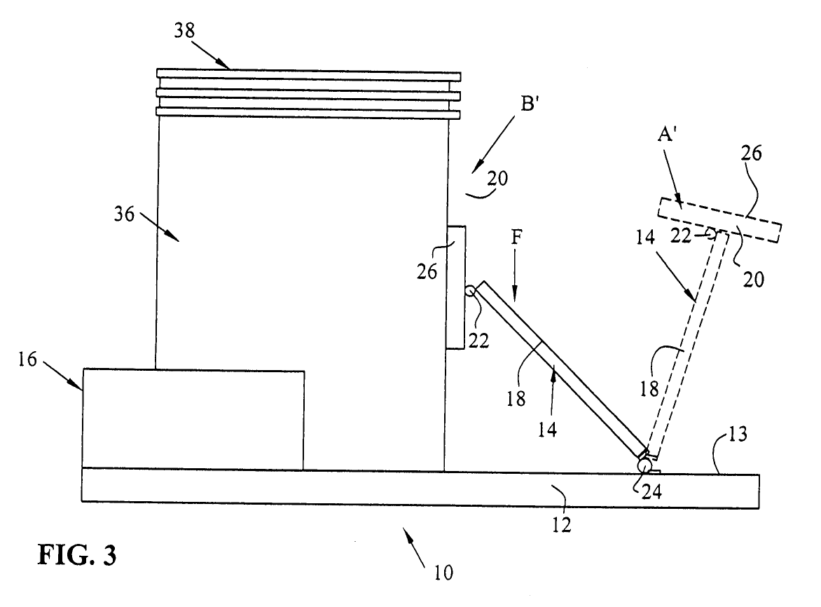

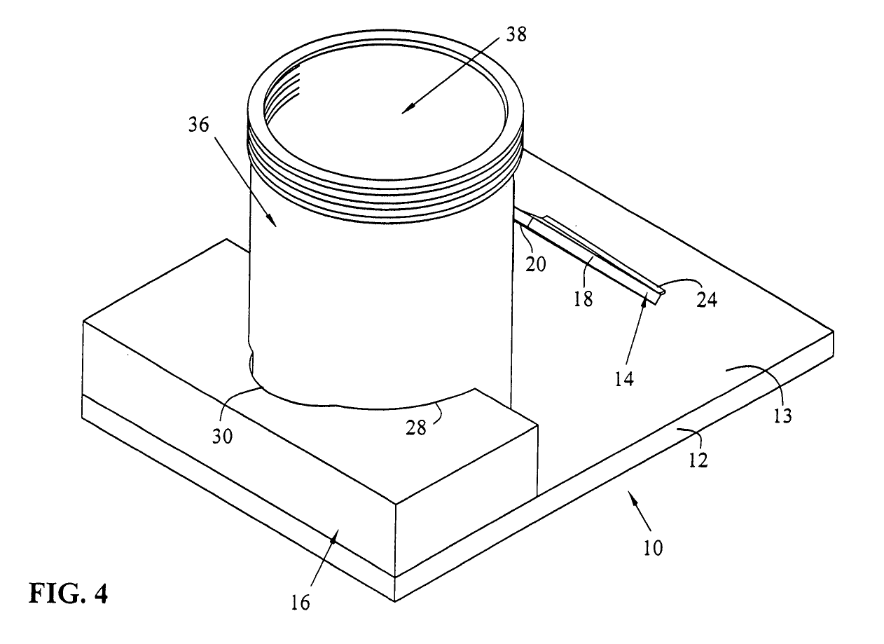

With reference now to FIG. 3, the loading operation of the apparatus prior to usage is illustrated. The first step in loading the apparatus 10 requires that the engagement arm 14 be rotated fully clockwise with respect to base 12 so that the engagement arm is located in the position indicated by A. Once engagement arm 14 has been rotated clockwise into the fully open position A, container 36 is placed into receiving portion 27 of brace assembly 16. Ideally, the outer surface of container 36 includes a shape complementary to either arcuate portions 28 or arcuate portion 30 of brace assembly 16, thereby allowing the outer surface of container 36 to fully contact the front face 32 of the complementary arcuate portions 28, 30. Once container 36 has been properly located within receiving portion 27, engagement arm 14 is then rotated into the position indicated by B′, so that engagement face 26 contacts the outer surface of container 36.

Now that container 36 has been properly positioned within the apparatus 10, the contents of container 36 may be mixed in a manner well known. It should be noted that this method involves the utilization of a mixing tool (not shown). Generally, mixing tools are well known in the art and comprise a variety of types. Furthermore, although a mixing tool is generally required for the method of mixing disclosed herein, the type of mixing tool may be of any type and does not constitute a part of the invention. For example, the method described herein may be accomplished regardless of whether the mixing tool constitutes a stick or a high-speed mixer.

Continuing with the description of the method of mixing, once engagement arm 14 has been moved into position B′ and contacts container 36, a force, indicated by F, is applied downward against first portion 18. It should be noted that an operator may apply force F against first portion 18 with a single foot (not shown). The application of force F to first portion 18 causes engagement face 26 to be forced against the outer surface of container 36. The contact between the engagement face 26 and the outer surface of the container 36 drives container 36 toward brace assembly 16. In addition, the contact between the outer surface of container 36 and engagement face 26 and front faces 32 retains container 36 in position and prevents container 36 from rotating. Furthermore, as explained previously, engagement face 26 may include some sort of covering or surface finish, thereby increasing the retention force supplied to container 36 by engagement arm 14.

After container 36 has been secured in apparatus 10, the mixing tool is then inserted into opening 38 of container 36, contacting the contents thereof. The contents of container 36 may be any substance required to be stirred, such as grout, paint, cement, etc. As the mixing tool stirs the contents of container 36, the container 36 is prevented from moving or spinning due to the force F applied to engagement arm 14. Consequently, an operator may mix the contents of container 36 using only one foot to retain container 36 in place.

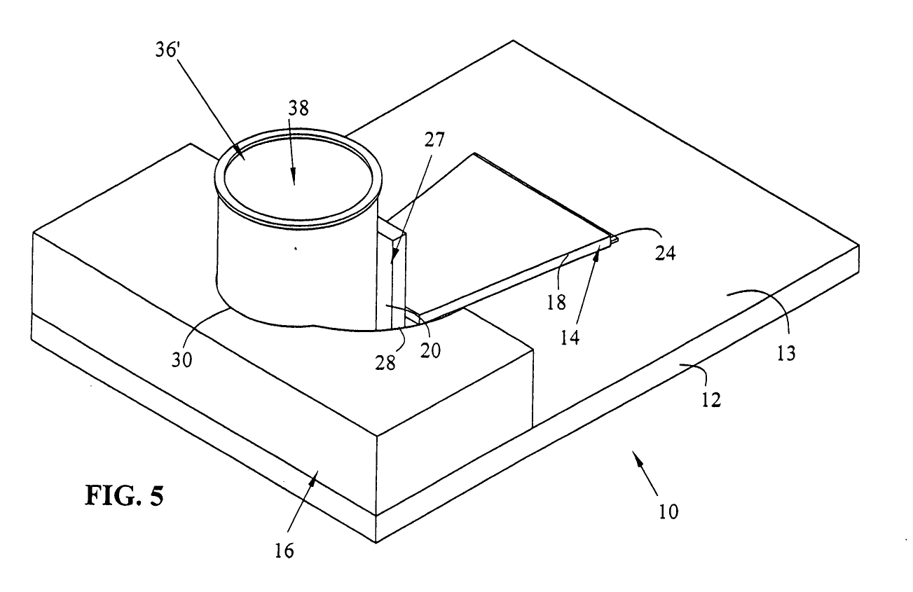

FIG. 5 illustrates the versatility of the present invention. For example, as seen specifically in FIG. 5, container 36 may be replaced with container 36′ having a diameter significantly smaller than that of container 36. Further, it should be appreciated that the diameter of container 36′ is such that the shape of container 36′ complements arcuate portion 30 of brace assembly 16. Accordingly, once container 36′ is placed within receiving portion 27, the outer surface of container 36′ contacts front face 32 (see FIG. 1) of arcuate portion 30. Consequently, apparatus 10 may retain, during mixing, a variety of containers 36 having different diameters without requiring the adjustment of apparatus 10 in any manner. Additionally, it should be appreciated also that the proper operation of apparatus 10 requires that the force be exerted only on first portion 18 of the engagement arm 14 regardless of the diameter of the container.

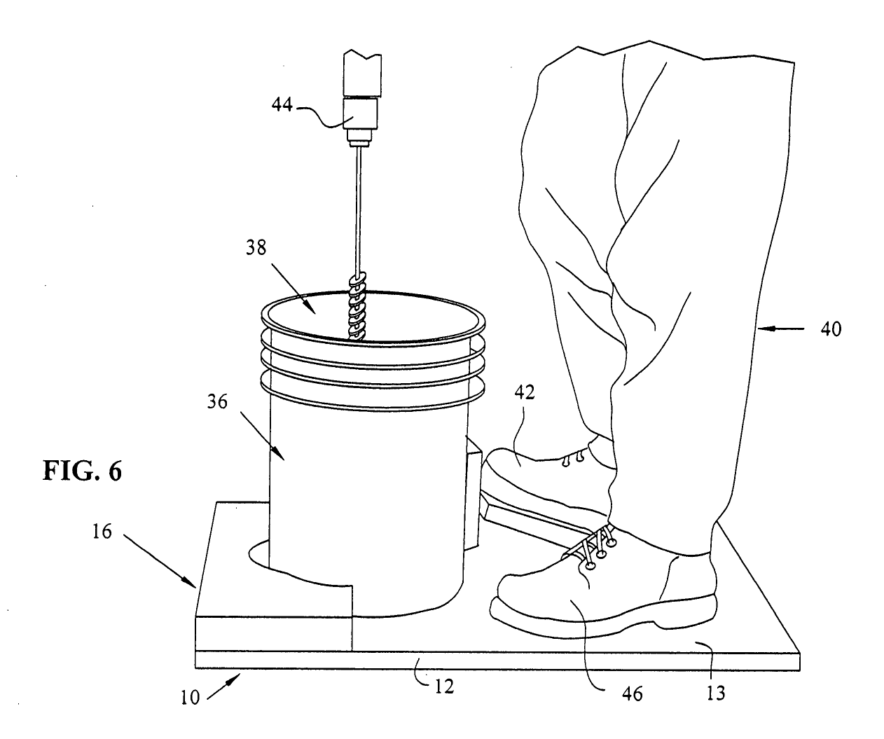

FIG. 6 depicts an additional advantage of the present invention, wherein an operator 40 may apply force to first portion 18 with only a first foot 42. Advantageously, while applying the force with foot 42, operator 40 may be positioned adjacent container 36, as depicted, rather than straddling container 36 as required in the prior art discussed above. Accordingly, operator 40 may hold the mixing device 44 away from his body during mixing. In addition, operator 40 is able to stand in a comfortable manner during mixing with his second foot 46 located adjacent his first foot 42. Finally, the assembly provides for easy engagement and disengagement with the container.

While this invention has been described as having an exemplary design, the present invention may be further modified within the spirit and scope of this disclosure. The application is, therefore, intended to cover any variations, uses, or adaptations of the invention using its general principles. Further, this application is intended to cover such departures from the present disclosure as come within known or customary practice in the art to which this invention pertains.

What I claim is:

1. An apparatus for securing a container during mixing comprising:
a base;
an arm attached to said base;
a brace member attached to said base;
whereby said arm and said brace member cooperate to retain said container.

2. The apparatus as set forth in claim 1, wherein said engagement arm includes a first member pivotally connected to a second member.

3. The apparatus as set forth in claim 2, wherein said arm is attached to said base by way of a hinge.

4. The apparatus as set forth in claim 1 wherein, said brace member is rigidly secured to said base.

5. The apparatus as set forth in claim 4, wherein said brace member includes a plurality of arcuate surfaces each configured to receive containers of different diameters.

6. The apparatus as set forth in claim 4, wherein said brace member comprises a plurality of stoppers.

7. The apparatus as set forth in claim 2, wherein a force applied downward to said first member forces said second member against said container.

8. An apparatus for securing a container during mixing comprising:
a base;
means for bracing said container and preventing rotation thereof; and
means for engaging said container and forcing said container into said bracing means.

9. The apparatus as set forth in claim 8, wherein said bracing means is rigidly fixed to said base.

10. The apparatus as set forth in claim 9, wherein said bracing means includes at least one arcuate surface sized to receive said container.

11. The apparatus as set forth in claim 10, wherein said arcuate surfaces include means for increasing the retention force of said arcuate surfaces.

12. The apparatus as set forth in claim 8, wherein said engaging means includes a first member pivotally attached to a second member.

13. The apparatus as set forth in claim 12, wherein said second member includes a means for gripping said container when said engagement means are forced against said container.

14. A method of stirring the contents of a container comprising the steps of:
(a.) providing an apparatus for securing said container including:
a base;
a brace member; and
an engagement arm pivotally attached to said base;
(b.) placing said container intermediate said brace member and said engagement arm;
(c.) applying a downward force with only a first foot of an operator to retain said container between said arm and said engagement portion;
(d.) mixing the contents of said container;
(e.) removing said downward force from said engagement arm; and
(f.) removing said container from said apparatus.

15. The method as set forth in claim 14, wherein a second foot of said operator is located adjacent said first foot while applying said downward force.

16. The method as set forth in claim 14, wherein said brace member includes a plurality of arcuate surfaces for receiving containers of various sizes.

17. The method as set forth in claim 14, wherein step (b.) further comprises placing said container in a receiving portion of said brace member.

18. The method as set forth in claim 11, wherein said engagement arm includes a first member pivotally connected to a second member.

19. The method as set forth in claim 18, wherein step (c.) further comprises rotating said second member into an engagement position substantially parallel to an outer surface of said container.
